(19) United States
(12) Patent Application Publication
(10) Pub. No.: US 2019/0292413 A1
(43) Pub. Date: Sep. 26, 2019

(54) ADHESIVE COMPOSITION FOR STATIONERY AND LAMINATE

(71) Applicant: PLUS Corporation, Tokyo (JP)

(72) Inventors: Hiroo FUKUNAGA, Tokyo (JP); Takuma TAKAGAWA, Tokyo (JP)

(21) Appl. No.: 16/286,785

(22) Filed: Feb. 27, 2019

(30) Foreign Application Priority Data
Mar. 23, 2018 (JP) 2018-055882

(51) Int. Cl. C09J 7/38; B32B 27/08; B32B 7/12; C09J 11/04

(52) U.S. Cl. CPC C09J 7/385; B32B 27/08; C08K 7/06; C09J 11/04; B32B 2405/00; B32B 7/12

(57) ABSTRACT

To provide an adhesive composition for stationery capable of forming an adhesive layer having a good glue-cutting property while suppressing an increase in manufacturing cost and a laminate using the adhesive composition.

Carbon fibers having an aspect ratio in the range of 6 to 30 were compounded in an adhesive component, such as an acrylic resin, to give an adhesive composition for stationery. The adhesive composition is applied onto one surface of a base material 1, such as a plastic film or paper, to form an adhesive layer 2, and thus a laminate 10, such as a glue tape, a seal, and a label, is obtained.

### TECHNICAL FIELD

The present invention relates to an adhesive composition to be used for stationery, such as a glue tape, a seal, and a label, and a laminate using the adhesive composition.

### BACKGROUND ART

A so-called “Glue Tape” using a pressure sensitive transfer adhesive tape is generally configured so that an adhesive layer is releasably provided on a base material such as a plastic film. When used, the adhesive layer is transferred onto an adherend using a transfer tool. Therefore, the adhesive layer of the transfer adhesive tape has been required to have a “glue-cutting property” which enables easy cutting at an arbitrary position without causing stringiness or the like in addition to adhesive strength. Similarly, adhesive layers of a seal, a label, and the like have also been required to have a “glue-cutting property” which enables easy punching processing or releasing from a base material without causing stringiness or the like in the punching processing or in use.

Heretofore, in order to improve the glue-cutting property, a transfer type adhesive tape in which a component of an adhesive composition configuring an adhesive layer is specified has been proposed (see Patent Documents 1 and 2). For example, Patent Document 1 discloses an adhesive tape in which alginic acid is made to contain in the adhesive layer. Patent Document 2 discloses an adhesive tape in which the adhesive layer is formed by an adhesive composition in which a tackifying resin and a crosslinking agent are compounded in a specific ratio in an acrylic copolymer.

Moreover, an acrylic adhesive composition in which the average molecular weight of an acrylic copolymer and the acid value index and the softening point index of a tackifying resin are set in specific ranges in order to improve punching processability has also been proposed (see Patent Document 3). Meanwhile, there is also an adhesive tape in which an improvement of the glue-cutting property is achieved by specifying a filler to be compounded in an adhesive layer (see Patent Documents 4 and 5). Specifically, needle-like particles are compounded in the adhesive layer in the adhesive tape described in Patent Document 4 and scale-like particles are compounded in the adhesive layer in the adhesive tape described in Patent Document 5.

### CITATION LIST

### Patent Documents

[Patent Document 1] JP-A No. H05-239413

[Patent Document 2] JP-A No. 2002-188062

[Patent Document 3] JP-A No. 1107-278513

[Patent Document 4] JP-A No. 2003-113353

[Patent Document 5] JP-A No. 2006-219605

### SUMMARY OF THE INVENTION

### Technical Problem

However, a sufficient glue-cutting property cannot be secured simply by devising the compositions or the characteristics of adhesive components as with the adhesive compositions described in Patent Documents 1 to 3. Although a mineral-based filler or glass fibers described in Patent Documents 4 and 5 have an effect of improving the glue-cutting property, the glue-cutting property is likely to vary when the addition amount thereof is small. In order to obtain a good glue-cutting property, the addition amount of the filler or the fibers needs to increase. Therefore, the addition of the mineral-based filler or the glass fibers has a problem of causing an increase in manufacturing cost.

Thus, it is an object of the present invention to provide an adhesive composition for stationery capable of forming an adhesive layer having a good glue-cutting property while suppressing the increase in the manufacturing cost and a laminate using the adhesive composition.

### Solution to Problem

An adhesive composition for stationery according to the present invention contains an adhesive component and a carbon fiber having an aspect ratio of 6 to 30.

The adhesive component is an acrylic adhesive, for example.

In the adhesive composition for stationery of the present invention, 0.1 to 3 parts by mass of the carbon fibers can be compounded based on 100 parts by mass of the adhesive component, for example.

As the carbon fiber, a PAN-based carbon fiber is usable, for example.

A laminate according to the present invention has a base material and an adhesive layer formed on one surface of the base material and containing the adhesive composition described above.

In the laminate, the adhesive layer is releasable from the base material.

In that case, a mold-release layer may be provided on the surface on which the adhesive layer is formed of the base material.

The laminate of the present invention is a pressure sensitive transfer adhesive tape, for example.

### Advantageous Effects of Invention

According to the present invention, a glue-cutting property equal to or higher than that of a conventional adhesive composition can be stably obtained with a filler addition amount smaller than that of the conventional adhesive composition, and therefore an adhesive layer having a good glue-cutting property can be formed while suppressing an increase in manufacturing cost.

### BRIEF DESCRIPTION OF DRAWINGS

FIG. 1 is a cross-sectional view schematically illustrating the configuration of a laminate of the second embodiment of the present invention.

FIG. 2 is a cross-sectional view schematically illustrating the other configuration of the laminate of the second embodiment of the present invention.

### DESCRIPTION OF EMBODIMENTS

Hereinafter, an embodiment for carrying out the present invention is described in detail with reference to the attached drawings. The present invention is not limited to embodiments described below.

### First Embodiment

First, an adhesive composition for stationery (hereinafter also referred to as an “adhesive composition”) according to the first embodiment of the present invention is described. The adhesive composition of this embodiment is used for stationery, such as a glue tape, a seal, and a label, and contains an adhesive component and carbon fibers having an aspect ratio of 6 to 30.

### [Adhesive Component]

The type of the adhesive component is not particularly limited and can be selected and used as appropriate according to the intended use or demand characteristics and, for example, an acrylic adhesive is usable. The acrylic adhesive to be compounded in the adhesive composition of this embodiment may be either a solvent type or an emulsion type insofar as an acrylic copolymer is used or two or more kinds thereof may be mixed and used. Moreover, in the adhesive component, an antiaging agent, a softener, a tackifier, a crosslinking agent, a filler, and the like may be compounded.

### [Carbon Fiber]

The carbon fibers have an effect of improving a glue-cutting property of an adhesive layer to be formed, have less variation in the glue-cutting property in the same lot or between lots as compared with a mineral-based filler or glass fibers used heretofore, and can achieve an effect equal to or higher than that of the mineral-based filler or the glass fibers with a small addition amount. However, when the aspect ratio of the carbon fibers is less than 6, a glue-cutting property improvement effect cannot be obtained. When carbon fibers having an aspect ratio of more than 30 are used, the coatability decreases and a defect occurs in the formation of the adhesive layer. Therefore, in the adhesive composition of this embodiment, carbon fibers having an aspect ratio of 6 to 30 are used.

In the carbon fibers to be compounded in the adhesive composition of this embodiment, the major axis is preferably 30 to 300 μm and more preferably 50 to 200 μm from the viewpoint of the glue-cutting property and the coatability. Thus, the occurrence of a defect in the formation of the adhesive layer is suppressed while improving the glue-cutting property, so that an adhesion composition excellent in a glue-cutting property and production aptitude can be obtained.

Herein, the “aspect ratio” is a ratio (major axis/minor axis) of the maximum major axis to a width (minor axis) orthogonal to the maximum major axis of the carbon fibers. The “major axis” and the “minor axis” of the carbon fibers can be measured by a microscopic method using a scanning electron microscope (SEM), an optical microscope, or the like.

The carbon fibers include a PAN (Polyacrylonitrile) type, a pitch type, a lignin type, a rayon type, and the like and the type of the carbon fibers to be compounded in the adhesive composition of this embodiment is not particularly limited and any carbon fiber is usable but PAN-based carbon fibers having high hardness are preferable from the viewpoint of the glue-cutting property. By the use of the PAN-based carbon fibers, the glue-cutting property of an adhesive layer to be formed can be further improved particularly when the adhesive component is an acrylic adhesive.

The compounded amount of the carbon fibers can be set as appropriate according to the type or the size of the carbon fibers, a demanded glue-cutting property, and the like and is 0.1 to 3 parts by mass based on 100 parts by mass of the adhesive component, for example. When the carbon fiber compounded amount is less than 0.1 part by mass based on 100 parts by mass of the adhesive component, a sufficient glue-cutting property is not obtained in some cases. When the carbon fiber compounded amount exceeds 3 parts by mass, a defect is likely to occur in a process of manufacturing a laminate, e.g., a streak is generated when the adhesive composition is applied to a base material.

The adhesive composition of this embodiment is used for stationery and electroconductivity or thermal conductivity is unnecessary, and therefore the addition of a large amount of the adhesive composition as with an electroconductive or thermally conductive adhesive is unnecessary. Moreover, the adhesive composition of this embodiment can form an adhesive layer having a good glue-cutting property even with a filler addition amount of less than 0.5 part by mass, which is smaller than that of a conventional article.

### [Other Components]

In the adhesive composition of this embodiment, a tackifier, a surface tension adjuster, a thickening agent, and the like may be compounded in a range where the effects of the present invention are not affected in addition to the components described above. However, the adhesive composition of this embodiment does not contain an additive for imparting electroconductivity or thermal conductivity, such as metal powder.

As described above in detail, the adhesive composition of this embodiment contains the carbon fibers as a component improving the glue-cutting property, and therefore can form an adhesive layer having a good glue-cutting property with an addition amount smaller than that of a mineral-based filler or glass fibers. As a result, the use of the adhesive composition of this embodiment enables the formation of an adhesive layer having good adhesive strength, a good running property, and a good glue-cutting property while suppressing an increase in manufacturing cost.

The adhesive layer formed by the adhesive composition of this embodiment has less variation in the glue-cutting property as compared with a conventional article having an equivalent filler addition amount and can achieve uniform and stable performance by being applied to stationery, such as glue tape, a seal, and a label. Furthermore, the adhesive composition of this embodiment has an effect that a pasted region (pasted surface) is easily visually recognized as compared with a conventional article containing glass fibers or a mineral-based filler.

### Second Embodiment

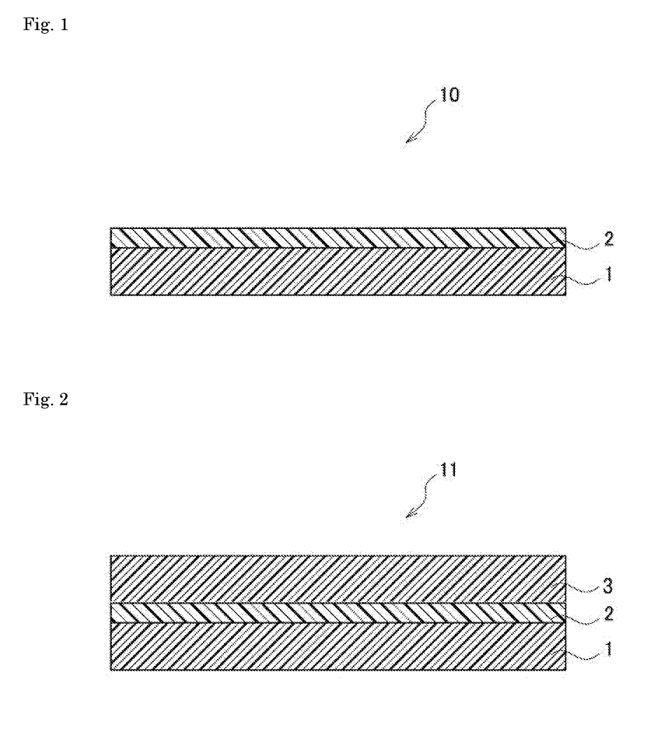

Next, a laminate according to the second embodiment of the present invention is described. FIG. 1 is a cross-sectional view schematically illustrating the configuration of a laminate of this embodiment. As illustrated in FIG. 1, a laminate 10 of this embodiment is stationery, such as a glue tape, a seal, and a label, in which an adhesive layer 2 containing the adhesive composition of the first embodiment described above is formed on one surface of a base material 1.

### [Base Material 1]

As the base material 1, polyester films, such as polyethylene terephthalate film and polyethylene naphthalate film, various plastic films, such as a polycarbonate film, a polymethyl methacrylate film, a polyethylene film, a polypropylene film, a polyimide film, and a polyvinylchloride film, paper, glassine, and nonwoven fabric are usable, for example. The thickness of the base material 1 is not particularly limited and can be set to 5 to 60 μm, for example.

When the laminate 10 is a pressure sensitive transfer adhesive tape (glue tape), a mold-release layer may be provided on the surface on the side of the adhesive layer 2 of the base material 1 or mold-release treatment may be performed thereto in order to enable easy releasing of the adhesive layer 2 from the base material 1. The mold-release layer can be formed by applying mold release agents, such as a silicone compound, a fluororesin, and a fluorosilicone resin.

### [Adhesive Layer 2]

The adhesive layer 2 can be formed by applying the adhesive composition of the first embodiment onto the base material 1 by a known method, for example. The thickness of the adhesive layer 2 is not particularly limited. When the laminate 10 is a pressure sensitive transfer adhesive tape (glue tape), the thickness is 5 to 40 μm, for example, when the adhesive strength or the glue-cutting property to the paper surface or the like is taken into consideration. In the case where the laminate 10 is a seal or a label, the thickness is 3 to 60 μm, for example, when the operation aptitude, such as processability in a printing machine, is taken into consideration.

### [Release Paper 3]

In the laminate 10 of this embodiment, a mold-release paper may be further laminated on the adhesive layer 2. FIG. 2 is a cross-sectional view schematically illustrating the other configuration of the laminate of this embodiment. For example, when used as a seal or a label, the adhesive layer 2 is formed on the base material 1 so as not to be able to be released and a release paper 3 may be laminated on the adhesive layer 2 as with the laminate 11 illustrated in FIG. 2. When the laminate 11 is used, the release paper 3 is released, so that the adhesive layer 2 is exposed.

The laminate of this embodiment can improve a glue-cutting property while maintaining adhesive strength and a running property because the adhesive layer is formed by the adhesive composition of the first embodiment described above. Moreover, the carbon fibers compounded in the adhesive composition of the first embodiment can stably achieve the glue-cutting property equal to or higher than that of a mineral-based filler or glass fibers with a compounded amount smaller than that of the mineral-based filler or the glass fibers, and therefore the manufacturing cost can also be suppressed.

### EXAMPLES

Hereinafter, the effects of the present invention are specifically described with reference to Examples and Comparative Examples. In Examples, adhesive compositions of Examples and Comparative Examples were produced using adhesives given in the following table 1 and fillers given in the following table 2, and then the glue-cutting property and the adhesive strength were evaluated.

TABLE 1

| No. | Type | Tg (° C.) |
|---|---|---|
| A | Aqueous acryl | −12.0 |
| B | Aqueous acryl | −14.0 |

TABLE 2

| | | | Average | Average | |
|---|---|---|---|---|---|
| | | | minor | major | |
| | | | axis | axis | Aspect |
| No. | Type | Shape | (μm) | (μm) | ratio |
| I | PAN-based carbon fibers | Fiber | 7.0 | 156.6 | 22.4 |
| II | PAN-based carbon fibers | Fiber | 7.4 | 117.7 | 15.9 |
| III | PAN-based carbon fibers | Fiber | 7.3 | 53.9 | 7.4 |
| IV | PAN-based carbon fibers | Fiber | 7.2 | 26.1 | 3.6 |
| V | Pitch-based carbon fibers | Fiber | 12.9 | 153.1 | 11.8 |
| VI | Graphite | Granule | 4.2 | 4.6 | 1.1 |
| VII | Glass fibers | Fiber | 12.6 | 168.0 | 13.3 |

### <Glass Transition Temperature (Tg)>

The glass transition temperatures (Tg) of the adhesives given in the Table 1 above were measured under the conditions where the measurement frequency was 1 Hz using a dynamic viscoelasticity meter.

### <Average Major Axis, Average Minor Axis, Aspect Ratio>

The minor axes and the major axes of No. I to No. V carbon fibers given in the Table 2 above, No. VI graphite, and No. VII glass fibers were measured by a microscopic method using an optical microscope. Specifically, 50 fillers, the shapes of which can be independently recognized, were measured for the major axis and the minor axis in an environment of a temperature of 23±2° C. and a humidity of 50±5% RH using an optical microscope (Leica DM2700M) manufactured by Leica Microsystems, Inc., and then the average thereof was taken. Then, the aspect ratio of each filler was calculated using the values.

The adhesive compositions of Examples and Comparative Examples were evaluated by methods described below.

### <Glue-Cutting Property>

The glue-cutting property was evaluated by producing a sample for evaluation having a width of 8.4 mm and a thickness of 20±2 μm, setting a gauge length L₀ to 10 mm, and then performing the evaluation based on the elongation at break. Specifically, the elongation at break of each sample for evaluation was measured by performing a tensile test at a tensile speed of 600 mm/min in an environment of a temperature of 23±2° C. and a humidity of 50±5% RH using a table-top tester (EZ-SX) manufactured by Shimadzu Corporation.

The measurement was performed 10 times for one sample. Then, the sample in which the average value of values (L₁−L₀) obtained by subtracting the initial gauge length L₀ from a gauge length L₁ when the sample was broken (gauge length at break) was 1.0 mm or more and 30.0 mm or less was evaluated to be very good (⊙), the sample in which the average value was more than 30.0 mm and 60.0 mm or less was evaluated to be good (◯), and the sample in which the average value was more than 60.0 mm or the sample in which the average value was less than 1.0 mm was evaluated to be defective (x).

### <Adhesive Strength Reduction Rate>

The adhesive strength to a stainless steel (SUS) plate of each adhesive composition was measured by a measuring method based on JIS Z 0237, and then a ratio of the adhesive strength to the adhesive strength of one in which the adhesive was the same and no filler was added (adhesive strength reduction rate) was determined. The sample in which the adhesive strength reduction rate was 80.0% or more was evaluated to be very good (⊙), the sample in which the adhesive strength reduction rate was 60% or more and less than 80% was evaluated to be good (◯), and the sample in which the adhesive strength reduction rate was less than 60% was evaluated to be defective (x).

### <Over-all Evaluation>

As the overall evaluation, the sample in which both the glue-cutting property and the adhesive strength were evaluated to be very good (⊙) was evaluated to be very good (⊙), the sample in which either or both the glue-cutting property or/and the adhesive strength was/were evaluated to be good (◯) was evaluated to be good (◯), and the sample in which either or both the glue-cutting property or/and the adhesive strength was/were evaluated to be defective (x) was evaluated to be defective (x).

All the results above are given in the following table 3.

TABLE 3

| | | Adhesive composition | | | | Evaluation result | | | | | |
|---|---|---|---|---|---|---|---|---|---|---|---|
| | | Adhesive | | Filler | | | | | | | |
| | | | Compounded | | Compounded | Glue-cutting property | | | Adhesive strength | | |
| | | | amount | | amount | L₁-L₀ | Standard | | Reduction | | Over-all |
| | No. | No. | (part by mass) | No. | (part by mass) | (mm) | deviation | Evaluation | rate (%) | Evaluation | evaluation |
| Comparative | 1 | A | 100 | — | — | 98.3 | 82.8 | X | — | — | X |
| Example | | | | | | | | | | | |
| Example | 2 | A | 100 | I | 0.05 | 32.6 | 47.9 | ◯ | 94.1 | ⊙ | ◯ |
| Example | 3 | A | 100 | I | 0.10 | 10.6 | 8.1 | ⊙ | 90.2 | ⊙ | ⊙ |
| Example | 4 | A | 100 | I | 1.00 | 5.6 | 3.0 | ⊙ | 89.6 | ⊙ | ⊙ |
| Example | 5 | A | 100 | I | 3.00 | 5.6 | 3.4 | ⊙ | 83.7 | ⊙ | ⊙ |
| Example | 6 | A | 100 | I | 3.50 | 5.6 | 3.5 | ⊙ | 79.4 | ◯ | ◯ |
| Example | 7 | A | 100 | II | 1.00 | 11.3 | 8.0 | ⊙ | 94.5 | ⊙ | ⊙ |
| Example | 8 | A | 100 | III | 1.00 | 11.7 | 6.2 | ⊙ | 99.9 | ⊙ | ⊙ |
| Comparative | 9 | A | 100 | IV | 1.00 | 200< | — | X | 100.0 | ⊙ | X |
| Example | | | | | | | | | | | |
| Example | 10 | A | 100 | V | 1.00 | 54.0 | 54.9 | ◯ | 94.0 | ⊙ | ◯ |
| Comparative | 11 | A | 100 | VI | 1.00 | 200< | — | X | 89.6 | ⊙ | X |
| Example | | | | | | | | | | | |
| Comparative | 12 | A | 100 | VII | 0.10 | 85.6 | 98.6 | X | 90.4 | ⊙ | X |
| Example | | | | | | | | | | | |
| Comparative | 13 | B | 100 | — | — | 172.1 | 24.8 | X | — | — | X |
| Example | | | | | | | | | | | |
| Example | 14 | B | 100 | I | 1.00 | 13.5 | 6.7 | ⊙ | 94.7 | ⊙ | ⊙ |

As given in the Table 3 above, in Nos. 2 to 8, 10, and 14 adhesive compositions in which the carbon fibers having an aspect ratio of 6 to 30 were added, the glue-cutting property of the adhesive layer was good and hardly varied. Particularly in Nos. 3 to 5, 7, 8, and 14 adhesive compositions in which 0.1 to 3 parts by mass of the PAN-based carbon fibers were added, both the glue-cutting property and the adhesive strength of the adhesive layer were excellent. On the other hand, in Nos. 1 and 13 adhesive compositions in which no filler was added, the glue-cutting property was poor. In No. 11 adhesive composition in which the graphite was added and No. 12 adhesive composition in which the glass fibers were added, the adhesive strength was good but the glue-cutting property was poor.

It was confirmed from the results above that the present invention can form a good adhesive layer having a good glue-cutting property without increasing the manufacturing cost.

### REFERENCE SIGNS LIST

1: base material
2: adhesive layer
3: release paper
10, 11: laminate

1. An adhesive composition for stationery comprising:
an adhesive component; and
a carbon fiber having an aspect ratio of 6 to 30.

2. The adhesive composition for stationery according to claim 1, wherein
the adhesive component is an acrylic adhesive.

3. The adhesive composition for stationery according to claim 1, wherein
0.1 to 3 parts by mass of the carbon fibers are compounded based on 100 parts by mass of the adhesive component.

4. The adhesive composition for stationery according to claim 1, wherein
the carbon fiber is a PAN-based carbon fiber.

5. A laminate comprising:
a base material; and
an adhesive layer formed on one surface of the base material and containing the adhesive composition according to claim 1.

6. The laminate according to claim 5, wherein
the adhesive layer is releasable from the base material.

7. The laminate according to claim 6, wherein
a mold-release layer is provided on the surface on which the adhesive layer is formed of the base material.

8. The laminate according to claim 5, which is a pressure sensitive transfer adhesive tape.
